(19) United States
(12) Patent Application Publication
(10) Pub. No.: US 2011/0158048 A1
(43) Pub. Date: Jun. 30, 2011

(54) SPIRAL SENSOR CONFIGURATION FOR SEISMIC BEAMFORMING AND FOCUSING

(76) Inventors: Jacques Y. Guigné, Paradise (CA); Nicholas G. Pace, Bath (GB)

(21) Appl. No.: 12/647,646

(22) Filed: Dec. 28, 2009

(51) Int. Cl. G01V 1/20

(52) U.S. Cl. 367/56

(57) ABSTRACT

A seismic sensor array includes a plurality of seismic sensors disposed on a line. The line is arranged in a spiral. The seismic sensors are disposed at at least one of equal angular spacing between adjacent sensors and equal linear spacing between adjacent sensors. A recording system is in signal communication with each of the seismic sensors. The recording system includes means for beam steering a response of the sensors.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of seismic exploration of subsurface rock formations. More particularly, the invention relates to seismic sensor configurations for relatively high frequency seismic exploration.

2. Background Art

International Patent Application Publication No. WO 2009/062286 filed by Guigné et al. describes a method for seismic imaging of subsurface rock formations. The described method disposing a plurality of seismic sensors in a selected pattern above an area of the Earth's subsurface to be evaluated. A seismic energy source is repeatedly actuated proximate the seismic sensors. Signals generated by the seismic sensors in response to detected seismic energy, indexed in time with respect to each actuation of the seismic energy source are recorded. The recorded signals are processed to generate an image corresponding to at least one point in the subsurface. The processing includes stacking recordings from each sensor for a plurality of actuations of the source and beam steering a response of the seismic sensors such that the at least one point is equivalent to a focal point of a response of the plurality of sensors.

The described method includes deployment of the seismic sensors in a plurality of lines extending radially from a center point to form an array. A longitudinal spacing between seismic sensors on each sensor cable, and a number of such seismic sensors on each cable may be determined by the frequency range over which a seismic analysis of the subsurface rock formations is to be performed. Such seismic frequencies, of course, must have been radiated by the seismic energy source. The longitudinal spacing between seismic sensors forming the receiver array is preferably selected such that for a particular seismic frequency the spacing should not be greater than about one-half the seismic energy wavelength. At each frequency an example cable length may be about 80 to 120 wavelengths of the longest wavelength seismic energy frequency. Thus, it is possible to use an array having sensor cables of overall length 120 wavelengths at the lowest frequency, but variable longitudinal spacing along each cable between the seismic sensors, so that the overall array will include 120 wavelength-long sensor arrays at higher frequencies with a half-wavelength spacing at such higher frequencies. The sound speed (seismic velocity) used to determine the wavelength is that within the rock formations near the water bottom (or the Earth's surface in land based surveys).

Using the technique described in the foregoing publication, however, requires custom made receiving element lines. Custom fabrication is considerably more expensive than commercially available seismic sensor arrays which have very well defined, equal spacing between individual seismic sensing elements but also bias for handling the conventional low frequencies typically seen in seismic mapping.

It is desirable to have a method for deploying seismic sensors usable with the techniques described in the foregoing publication that can use commercially available seismic sensor lines or streamers.

### SUMMARY OF THE INVENTION

A seismic sensor array according to one aspect of the invention includes a plurality of seismic sensors disposed on a line. The line is arranged in a spiral. The seismic sensors are disposed at at least one of equal angular spacing between adjacent sensors and equal linear spacing between adjacent sensors. A recording system is in signal communication with each of the seismic sensors. The recording system includes means for beam steering a response of the sensors.

Other aspects and advantages of the invention will be apparent from the following description and the appended claims.

### BRIEF DESCRIPTION OF THE DRAWINGS

FIG. 1 is an example of a spiral array of seismic sensors wherein a linear spacing between adjacent sensors is substantially equal.

FIG. 2 is an example of a spiral array of seismic sensors wherein an angle subtended between adjacent sensors with reference to a center of the array is substantially equal.

FIG. 3 represents an array of sensors in the XY plane according to either FIG. 1 of FIG. 2 in order to illustrate parameters related to beam steering using the array.

FIG. 4 illustrates beam steering using the array of FIG. 1 or FIG. 2.

FIGS. 5A, 5B and 5C represent, respectively, beam response of the array of FIG. 1, the array of FIG. 2 and a prior art hub and spoke array for a frequency ratio F of 0.5.

FIGS. 6A, 6B and 6C represent, respectively, beam response of the array of FIG. 1, the array of FIG. 2 and a prior art hub and spoke array for a frequency ratio F of 1.0

FIGS. 7A, 7B and 5C represent, respectively, beam response of the array of FIG. 1, the array of FIG. 2 and a prior art hub and spoke array for a frequency ratio F of 1.5.

### DETAILED DESCRIPTION

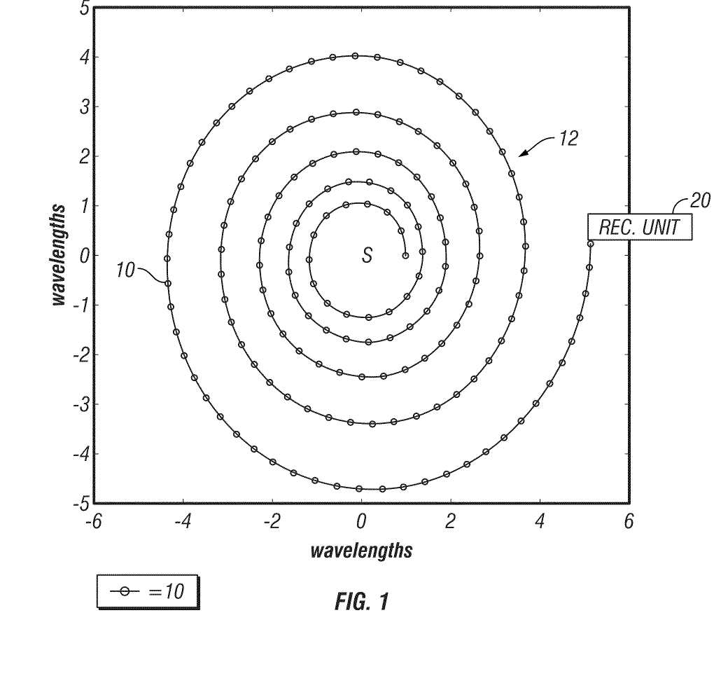

FIG. 1 shows one example of a seismic sensor array 12 according to the invention. The array 12 includes a plurality of seismic sensors 10 disposed in a single line (or a plurality of smaller lines connected end to end) of sensors. The array 12 is disposed above a volume of subsurface rock formations to be evaluated. In one example, the array 12 is deployed on the bottom of a body of water. In other examples, the array 12 may be deployed on or near the land surface.

The seismic sensors 10 each may be single component particle motion responsive sensors, multiple component particle motion sensors, pressure or pressure time gradient responsive sensors, or combinations of the foregoing types of sensors. The sensor array 12 is disposed in the form of a spiral as shown in FIG. 1. The sensors 10 generate electrical or optical signals corresponding to seismic amplitude at any moment in time. The signals are conducted to a recording unit 20, which makes a time indexed record of the signals generated by each sensor 10 in response to actuation of a seismic source S placed in a suitable location proximate the array 12. In the present example the source S may be in the geometric center of the array 12. The sensors 10 in the array 12 in FIG. 1 have equal linear spacing between adjacent sensors 10. The seismic energy source S may be of any type known in the art. More specifically, a seismic energy source such as the one described in International Patent Application Publication No. WO 2009/062286 (referred to in the Background section herein) may be advantageously used. Operation of the source S and the manner of making signal recordings and beam steering may be substantially as described in the foregoing publication. Generally, beam steering is performed by the recording unit 20 by adding a selected time delay to the recording corresponding to each seismic sensor 10. The time delay is selected for each sensor 10 such that response of the array may be amplified along a selected direction and attenuated along any other direction.

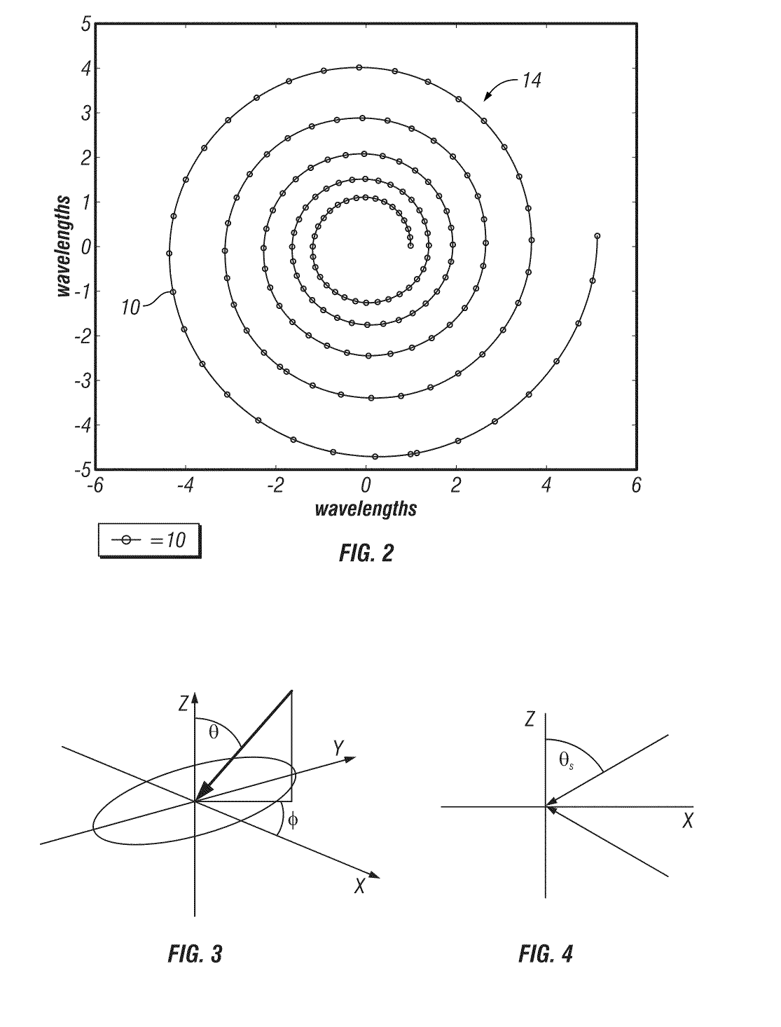

In another example array, shown at 14 in FIG. 2, the sensors 10 may be spaced along the spiral such that the angle subtended between adjacent sensors 10 with reference to the center of the spiral is substantially equal. The recording system and seismic source are omitted from FIG. 2 only for clarity of the illustration.

In order to define the geometry of the spiral in the array it is necessary to determine or define a desired overall array diameter, the total number of seismic sensors in the array and the spacing between individual seismic sensors. From the foregoing information the value of a parameter a is derived. The parameter a is related to the diameter of the array, D, measured in wavelengths of the seismic energy to be detected, and the spacing between the seismic sensors, d, also measured in wavelengths of the seismic energy to be detected. “Spacing as that term is used with reference to the spiral is measured in a direction along the spiral curve. In examples having equal linear spacing between adjacent sensors the spacing may be referred to by the parameter d. In examples of a spiral having equal angular spacing between adjacent sensors, the spacing is that which results from using the same total length of spiral, the same number of sensors, and distributing the sensors angularly equally throughout the total angular extent of the sensor line used to generate the spiral.

In a hub and multi spoke seismic array such as the one described in the WO 2009/062286 publication referred to in the Background section herein, the same array diameter could be used and sensors placed along each of the N radial arm at a radial spacing of d resulting in the same overall diameter D and the same number of sensors as in a spiral according to the present invention. For practical deployment and manufacturing of sensor lines, the spiral arrays described herein may have advantages as contrasted with the hub and multi spoke array known in the art. The overall diameter D of the spiral may be in the range of 80 to 120 wavelengths of the lowest frequency seismic energy imparted into the subsurface by the source (S in FIG. 1), and the spacing, d, between adjacent seismic sensors may be one half wavelength of the lowest frequency seismic energy imparted into the subsurface.

The length of a radius from the center of the spiral to any selected point on the spiral can be defined by the expression [symbol] . The parameter α is dimensionless and is determined, as will be explained below, by minimizing a relationship shown which connects the total length L of the spiral, the overall diameter D of the spiral and the radius R₀ from the spiral center to the first sensor location on the spiral. Such parameters are related to what is referred to as the “design frequency” of the array. The design frequency is the frequency to which the array will exhibit the greatest sensitivity to seismic energy.

The distance from the center of the spiral to the first sensor position on the spiral is determined by the expression [symbol] , and as may be inferred from the previous statement, such distance may be selected based on the design frequency of the array. The spiral is specified by the following equation where the angle φ can extend to the amount required to extend the spiral to the desired diameter D for a given value of α:

r=exp(αφ)

x=r cos(φ)=exp(αφ) cos(φ)

y=r sin(φ)=exp(αφ) sin(φ)

The sensors (10 in FIG. 1), as explained above, can either be placed at equal angular separation along the spiral (FIG. 2) or at equal linear separations (FIG. 1) along the spiral. The latter is more practical in the sense that a line array of equally spaced sensors, which are available commercially for conventional seismic exploration, can be readily deployed into a spiral. The former may have the advantage of providing the functional equivalent of radial lines of sensors (albeit with non-equal radial spacing) as described in the WO 2009/062286 publication referenced in the Background section herein. The total length of an equal sensor spacing array may be determined by the number of sensors and their linear spacing between adjacent sensors by the expression:

L=md

In order to perform beam steering, it is necessary to determine the coordinates of each sensor in the array. The coordinates of each of the sensors when deployed in a spiral having equal linear separation between adjacent sensors can be determined as follows. The length of an arc of the spiral between angles φᵢ and φᵢ+Δφ is equal to d where:

$${\int }_{{φ}_{i}}^{{φ}_{i} + Δ φ} r d φ = d$$

$$d = \frac{exp ( a ( {φ}_{i} + Δ {φ}_{i} ) ) - exp ( a {φ}_{i} )}{a}$$

The angular separation between each of the sensors Δφᵢ can be determined by the expression:

$${Δφ}_{i} = \frac{1}{a} {log}_{e} ( 1 + ad exp ( - a {φ}_{i} ) )$$

The angle at which each of the sensors is disposed is:

φᵢ=φᵢ₋₁+Δφᵢ where i=(1, m) and φ₁=φ, which determines how far from the center of the array that the first sensor is disposed.

Let R₀=exp(αφ) represent the distance the first sensor is from the center.

The total length of the line of sensors in the spiral is determined by the expression:

$$L = md = \frac{exp ( a {φ}_{m} ) - exp ( a Φ )}{a}$$

The diameter of the spiral D is taken as the average of two orthogonal measures of the diameter:

$$D = ( exp ( a {φ}_{m} ) + exp ( a ( {φ}_{m} + π / 2 ) ) + exp ( a ( {φ}_{m} + π ) ) + exp ( a ( {φ}_{m} + 3 π / 2 ) ) ) / 2$$

$$aL + {R}_{0} = exp ( a {φ}_{m} ) = \frac{2 D}{( 1 + exp ( a π / 2 ) + exp ( a π ) + exp ( a 3 π / 2 ) )}$$

Given the specified values of L, R₀ and D, the value of a can be obtained by a minimization of the expression:

$$\vert ( aL + {R}_{0} - \frac{2 D}{( 1 + exp ( a π / 2 ) + exp ( a π ) + exp ( a 3 π / 2 ) )} ) \vert$$

The physical size of the array remains as specified at F=1 where F is the ratio between the frequency at which the spacing of sensors along the spiral is a half wavelength of the frequency of operation (the frequency to which the array is most sensitive). A low frequency is indicated by F<1 and a high frequency is indicated by F>1. The beam patterns are the same regardless of the frequency provided that the spacing between seismic sensors is the same when measured in wavelengths of the seismic energy imparted into the subsurface. In the present example, the spacing between sensors is selected to be a half wavelength along the spiral at a particular frequency called the design frequency. If the seismic energy source emits energy at the design frequency, the ratio of the seismic energy frequency with respect to the design frequency is unity. If the seismic energy frequency changes, F changes, and the beam pattern changes. An important attribute of the spiral array is that the beam pattern changes with respect to F are small and are well known.

FIG. 3 represents an array of sensors in the XY plane disposed in a spiral according to either FIG. 1 of FIG. 2 in order to illustrate parameters related to beam steering using the arrays configured as explained above. Beam steering is performed by adding a suitable time delay to the signals recorded by each sensor in the array (12 in FIGS. 1 or 14 in FIG. 2) as explained above. The direction of the beam steered response may be defined by two angles, one in the XY (horizontal) plane and one in the XZ or YZ (vertical reference) plane.

FIG. 4 illustrates that when the beam is steered to angle θₛ with φ=0, that is, the array is disposed entirely in the XY plane, beams are formed in the ZX plane symmetrically with respect to the X axis. For θₛ=0 a broadside beam is generated along both the positive and negative Z axis. As θₛ increases, the beam splits and forms what is sometimes called the butterfly effect. When θₛ=90 the two beams coalesce. The steered beam width becomes asymmetrical as the full width of the array along the Y direction is still available and remains in a broadside configuration to give a narrow beam whilst the array along the X direction becomes increasingly an endfire configuration array as θₛ increases.

The foregoing may be better understood when explained in terms of a line array of sensors. When a straight line array of sensors is steered (e.g., using time delay for individual sensors) such array has a narrow beam width in a direction normal to its length if all sensor outputs are combined. This is called “broadside.” The broadside pattern has no directional preference in the orthogonal plane. If the outputs of the sensors have appropriate time delays applied, the beam can be steered to 90 degrees from the normal to length direction, so that in the limit the beam can point along the direction of the line. This is called “endfire”. The endfire beam pattern is much broader than the broadside beam pattern. If two line arrays are crossed, then the broadside beam will have directional preferences. In the limit, as many line arrays are crossed (at smaller and smaller angles between sensor line arrays), the broadside beam becomes conical with sidelobes. In the case of two crossed line arrays steered to endfire only one array actually becomes endfire and the other remains broadside. So now in the endfire direction the resultant beam for the two crossed lines is asymmetrical, having the narrowness of the broadside in one plane and the greater beam width of the endfire in the other. For the hub and spoke array described above steered to 90 degrees, the diameter of the array provides a narrow beam in one plane. In the other plane the beam is endfire and has somewhat greater vertical width. The spiral array has similar beam steering properties.

The spiral array is designed to operate over a range of frequencies. To explain the possible benefits of the spiral array, compared for example, to a filled square array of equally spaced sensors, the latter configuration would have a much larger number of sensors. The larger number of sensors would benefit the signal to noise ratio but would be relatively expensive. At the design frequency, where the grid spacing is a half wavelength, the beam pattern of the square array would consist of a main beam with well defined sidelobes which decrease with increasing angle off axis. This would persist as the main beam was steered. At frequencies higher than the design frequency extra sidelobes would appear, and as the beam is steered diffraction secondaries would appear. The diffraction secondaries are aliased versions of the main beam and are of the same strength.

In the spiral, the effective grid spacing is non uniform (except along the spiral itself) and the number of sensors is much smaller than the filled square. At the design frequency the main beam would be almost the same as the main beam of the filled square, but the sidelobes would be roughly constant at the level of the first sidelobe of the filled square. The foregoing sidelobe properties would persist as the main beam is steered. At frequencies higher than the design frequency, the sidelobes remain very similar but as the beam is steered no diffraction secondaries appear.

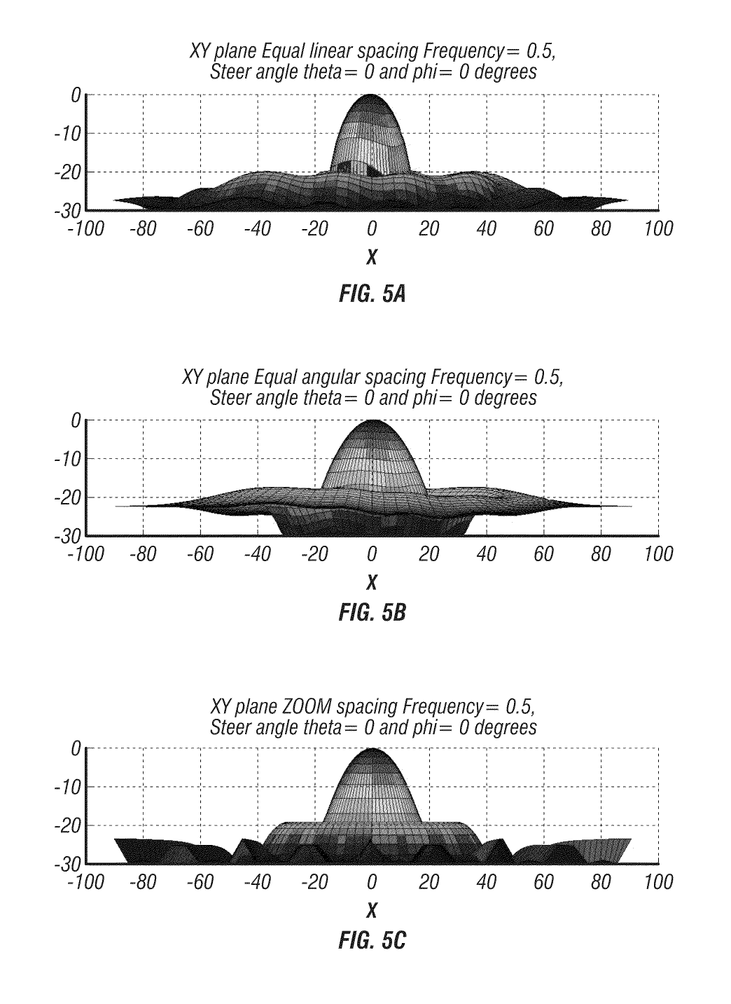

Response of the spiral arrays described above with reference to FIG. 1 and FIG. 2 was simulated and compared with simulated response of the hub and spoke array described in the WO 2009/062286 publication referenced in the Background section herein. FIG. 5A shows the response of a spiral array having equal linear spacing between adjacent sensors, with a beam steered straight down in the center of the array (φ=0 and θ=0 with reference to the geometric center of the array), and for a frequency ratio F=0.5. FIG. 5B shows simulated beam response for a spiral array having equal angular spacing between adjacent sensors. The frequency ratio F is also equal to 0.5 for the response simulation shown in FIG. 5B, and the beam is in the same direction as for the response shown in FIG. 5A. FIG. 5C shows simulated response of a hub and spoke array having equivalent diameter as the arrays simulated in FIGS. 5A and 5B, wherein the beam is also straight down from the center of the array.

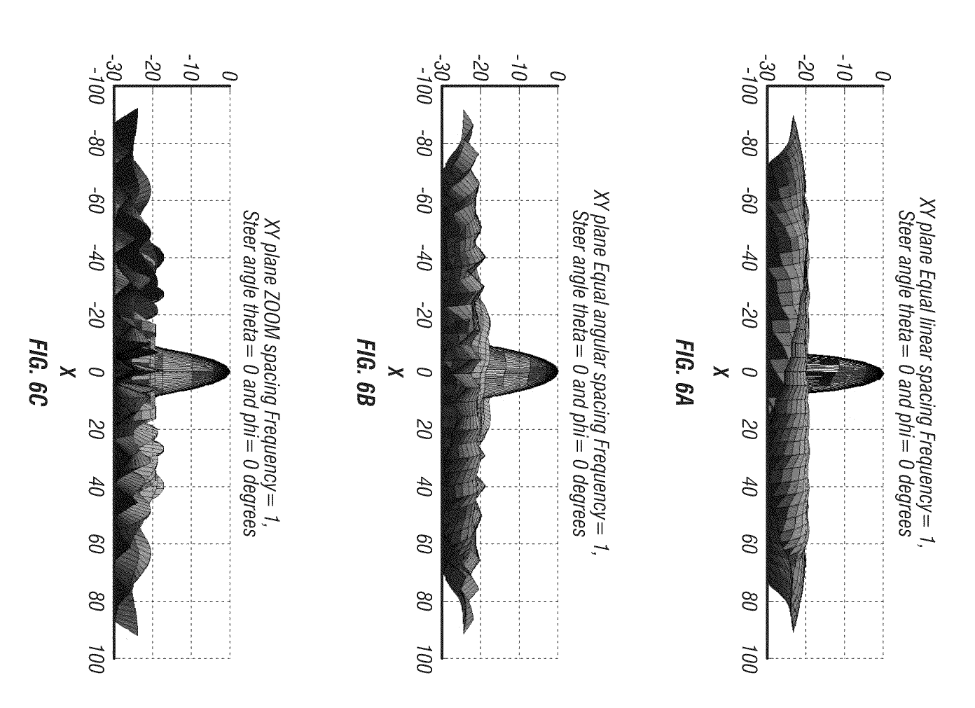

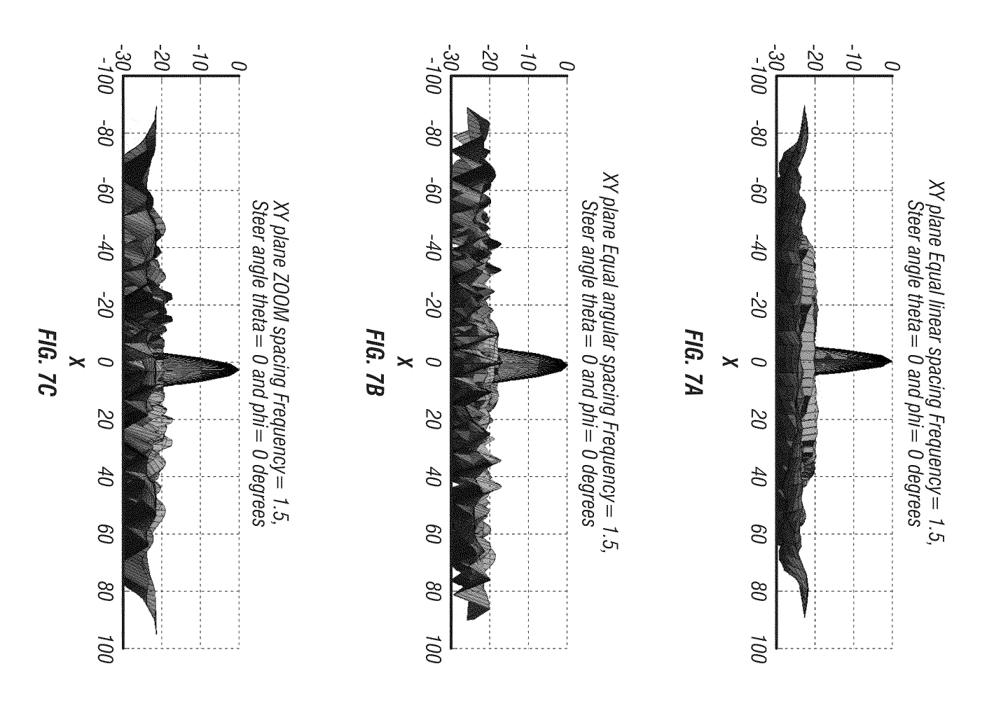

FIGS. 6A, 6B and 6C show simulated beam response for a spiral array according to FIG. 1, according to FIG. 2 and for a hub and spoke array, respectively. The responses in FIGS. 6A, 6B and 6C are for a frequency ratio F of 1.0. FIGS. 7A, 7B and 7C show corresponding simulated responses wherein the frequency ratio F is equal to 1.5. What can be observed in the foregoing figures is that using a spiral array it is possible to obtain substantially equal beam response without spatial aliasing as the response of a hub and spoke array of equivalent diameter.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims

What is claimed is:

1. A seismic sensor array, comprising:
a plurality of seismic sensors disposed on a line, the line arranged in a spiral, wherein the seismic sensors are disposed at at least one of equal angular spacing between adjacent sensors along the line and equal linear spacing between adjacent sensors along the line; and
a recording system in signal communication with each of the seismic sensors, the recording system including means for beam steering a response of the sensors.

2. The array of claim 1 wherein a diameter of the spiral is equal to a selected multiple of a wavelength of seismic energy imparted into subsurface rock formations.

3. The array of claim 1 wherein a spacing between adjacent sensors is equal to one half of a wavelength of seismic energy imparted into subsurface rock formations.

4. The array of claim 1 wherein a spacing between adjacent sensors, a diameter of the spiral and a position of a closest one of the sensors with respect to a center of the spiral are selected to cause the array to have greatest sensitivity to a selected frequency of seismic energy.

5. The array of claim 1 wherein the seismic sensors comprise particle motion responsive sensors.

6. The array of claim 1 wherein each particle motion sensor comprises three, mutually orthogonally arranged particle motion responsive sensors.

7. The array of claim 1 wherein the seismic sensors comprise pressure responsive sensors.
